(19) United States
(12) Patent Application Publication
(10) Pub. No.: US 2007/0112945 A1
(43) Pub. Date: May 17, 2007

(54) Supply and demand project management tool

(76) Inventors: Lori Brown, Glen Ellyn, IL (US); Steven Williams, Sleepy Hollow, IL (US); Joanne Marsceau, Cary, IL (US); Lars Sanders, Poplar Grove, IL (US); Lisa Dehorn, Watertown, WI (US); Thomas Reuther, Huntley, IL (US)

Correspondence Address: MATTHEW E. BURR;LAKE AUSTIN MARINA, 2219 WESTLAKE DR, STE 200, AUSTIN, TX, 78746, US

(21) Appl. No.: 11/271,515

(22) Filed: Nov. 12, 2005

(51) Int. Cl. G06F 15/173

(52) U.S. Cl. 709/223

(57) ABSTRACT

A scheduling engine calculates a difference between a forecast supply of Information Technology (IT) resources and a forecast demand for the IT resources at an application team level. One or more teams may impact the release of a product of a project, whether or not a specific team is assigned to the project. The scheduling engine has a release calendar to allocate IT resources on the basis of a calculated difference between a forecast IT team resource supply and a forecast IT team resource demand to achieve product deployment by a scheduled release date.

### FIELD OF THE DISCLOSURE

The present disclosure relates to information technology, and in particular to a project management scheduling engine.

### BACKGROUND

A number of computer software products exist for calculating resource needs when managing a project. Such applications, however, are typically intended and designed for managing a single project in a file and managing individual resources assigned to that project.

Project-based tools, however, typically do not provide a release calendar where each activity is created independently of all the others and then dependencies are added. This type of scheduling is good for effort-based projects without fixed end dates and with known resources.

However, many businesses, due to regulatory or business rules, work off a fixed release schedule with predetermined milestones. Projects are scheduled into these releases and must conform to the milestone dates. The present disclosure addresses project management under such constraints.

### BRIEF DESCRIPTION OF THE DRAWINGS

The present disclosure provides the detailed description that follows by reference to the noted drawings and by way of non-limiting examples of specific embodiments, in which reference numerals represent the same parts throughout the several views of the drawings, and in which:

FIG. 1 is a high level process flow chart for a specific exemplary embodiment of an IT resource supply and demand tool of the present disclosure.

FIG. 2 is a high level process flow chart for a specific exemplary embodiment of a demand management tool of the present disclosure.

FIG. 3 is a high level process flow chart for a specific exemplary embodiment of an IT resource supply and demand management tool interface of the present disclosure.

FIG. 4 is a high level process flow chart for a specific exemplary embodiment of a planning view of the present disclosure.

FIG. 5 is a high level process flow chart for a specific exemplary embodiment of a process to generate a project list/ineligible project list of the present disclosure.

FIG. 6 is a high level process flow chart for a specific exemplary embodiment of a commitment process of the present disclosure.

FIG. 7 is a high level process flow chart for a specific exemplary embodiment of a commit release process of the present disclosure.

FIG. 8 is a high level process flow chart for a specific exemplary embodiment of a process of the present disclosure to validate release eligibility.

FIG. 9 is a high level process flow chart for a specific exemplary embodiment of a process of the present disclosure to add project/change project information.

FIG. 10 is a high level process flow chart for a specific exemplary embodiment of an appeals process of the present disclosure.

FIG. 11 is a high level process flow chart for a specific exemplary embodiment of a process of the present disclosure to implement team changes.

FIG. 12 is a high level process flow chart for a specific exemplary embodiment of an import priority list process of the present disclosure.

FIG. 13 is a high level process flow chart for a specific exemplary embodiment of a Force All process of the present disclosure.

FIG. 14 is a high level process flow chart for a specific exemplary embodiment of a process of the present disclosure to update estimates.

FIG. 15 is a high level process flow chart for a specific exemplary embodiment of a process of the present disclosure to update project/defect status.

FIG. 16 is a high level process flow chart for a specific exemplary embodiment of an Other Demand (Demand Requests) process of the present disclosure.

FIG. 17 is a high level process flow chart for a specific exemplary embodiment of a process of the present disclosure to Estimate Changes.

FIG. 18 is a process flow chart of a specific exemplary embodiment of a scheduling engine of the present disclosure.

FIG. 19 is a diagrammatic illustration of a specific exemplary embodiment of a network of the present disclosure.

FIG. 20 is a diagrammatic representation of a machine in the form of a computer system 2000 within which a set of instructions, when executed, may cause the machine to perform any one or more of the methodologies discussed herein.

### DETAILED DESCRIPTION

In view of the foregoing, through one or more of its various aspects, embodiments and/or specific features or sub-components, the present description is thus intended to bring out one or more of the advantages that will be evident from the description. The description makes frequent reference to Information Technology (IT) resources. It is understood, however, that IT is merely an example of a specific embodiment, while the description is directed broadly to project management tools within the scope of the disclosure. Occasion reference may also be made in the course of the present description to brand name third party tools, which references, it is understood, are made only provide examples of functions that may be compatible with a tool of the present description and are not intended to limit the present disclosure. The terminology, examples, drawings and embodiments, therefore, are not intended to limit the scope of the disclosure.

The present disclosure describes a scheduling engine on a computer, for example, designed to calculate the difference between the supply of Information Technology (“IT”) resources (i.e., people and their available work hours) and the demand for resources at an application team level. Project demand infers the estimated number of hours required to complete the work. The tool of the present disclosure offers a view of all projects that impact a broad range of teams and encompasses all types of demand, whether project-based or not.

To work for businesses that employ fixed release dates and milestone dates for projects and products, the present tool allows project or team parameters to be adjusted and to affect all projects associated with that parameter going forward to be adjusted at one time. The present tool thus offers the advantage of simplifying the rescheduling of projects in a volatile environment.

An advantage of the present tool is that it shows the impact on a project of resources not assigned to the project. That is, resources do not have to be assigned to a project for their impact on the project to be examined. For example, in some products, if the business requirements activity extends past the project date and effort still remains, all dependencies will be adjusted affecting the delivery date of the project. Under the present disclosure, in contrast, the end date is fixed due to business and system dependencies. Therefore, if the business requirements miss the fixed release milestone, the release is changed to reflect the new release date to which the project is targeted and the project demand is re-scheduled to the new release calendar.

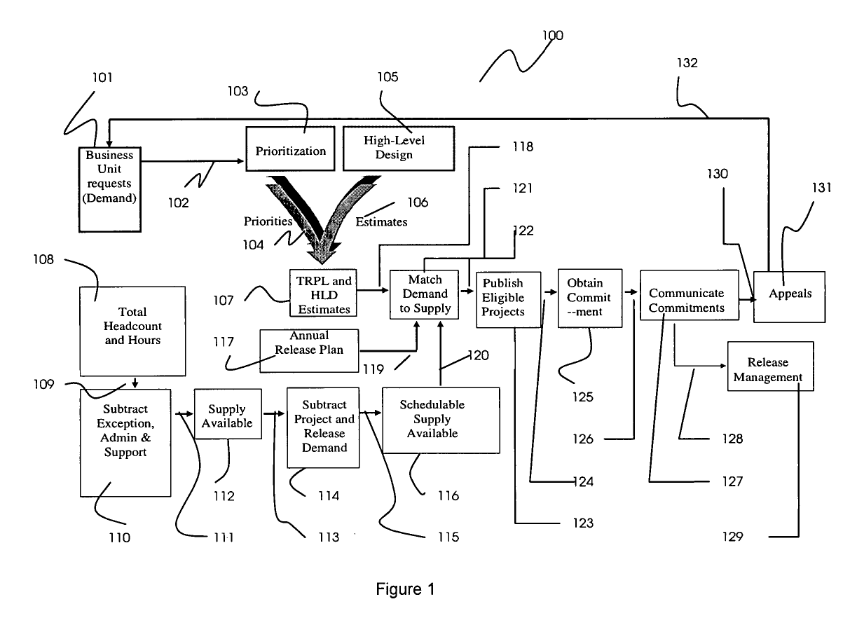

FIG. 1 is a high level process flow chart for a specific exemplary embodiment of an IT resource supply and demand tool of the present disclosure. Process 100 may be initiated from Business Unit 101 of an enterprise. Business Unit 101 requests IT resources. Each request is analyzed 102 and prioritized 103 to create priority hierarchy 104. High Level Design (“HDL”) 105 develops resource estimates 106. Priorities 104 and HDL estimates 106 are compared 107.

Resource supply is calculated from a variety of factors. Total personnel headcount and available work hours 108 is reduced 109 by exception, administration and support resources 110 to yield 111 gross supply available 112. Total hours 108 should equal the total hours entered for team on a supply data screen. Project and Release Demand 114 is subtracted 113 from supply available 112 to yield 115 schedulable supply available 116.

Supply Data may include the total headcount (HC), and hours for each team. The data is allocated to the following summary level supply categories: Exception; Administrative; and Support. These account for unavailable hours and non-discretionary, non-project related hours, for example. Supply hours entered into these categories on the Supply Data screen decrement from the total hours. The remainder is called “Supply Available” 111. Supply available 111 represents discretionary supply to be used for project demand for the business.

Supply Adjustments are primarily used, for example, to reflect changes to Supply Available resulting from loaning and borrowing resources to and from other teams. Adjustments may also be used to resolve over-allocations (such as with overtime) and to increased efficiencies.

Project and Release Demand 114 includes factors such as project hours not included in HLD estimates 106 and release hours not included in HLD estimates 106.

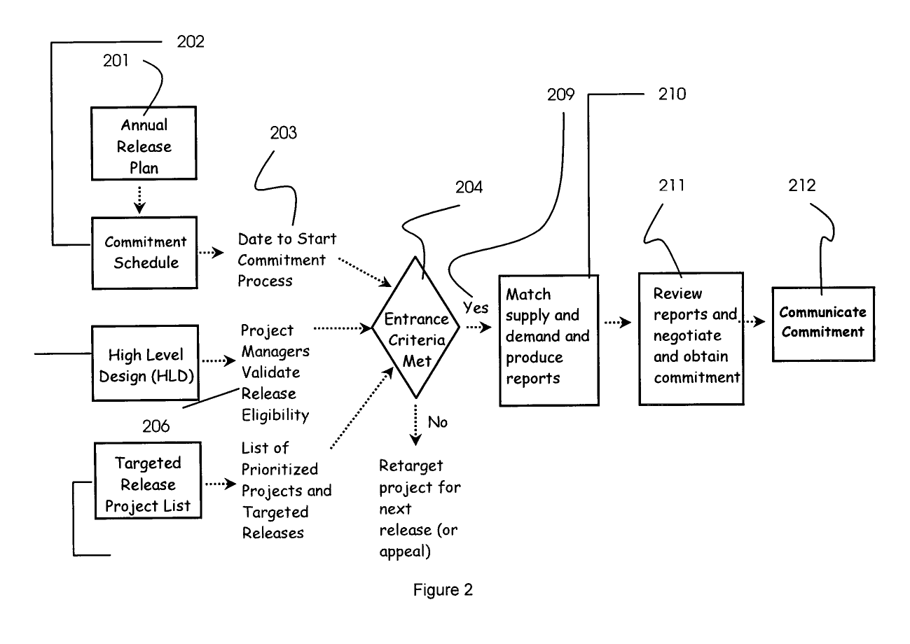

Priority and estimate comparison 107 may be factored into 118 matching supply and demand 121 together with 120 schedulable supply 116 and 119 Annual Release Plan 117 (see FIG. 2, below), to develop 122 publication of eligible projects 123. Published Projects are circulated 124 to obtain Project commitment 125. Committed Projects 127 are communicated 128 to Release Management 129.

Appeal process 131 may be provided for projects that do not obtain sufficient resources 130 so that the originating business unit 101 formulates a new request.

Among the first steps in supply and demand management is to establish supply teams and to create a Team Master Report. The Team Master Report may include general team information, such as, for example:

Team name

Team owner, director, AVP, VP

Supply contact

Commitment coordinator

Artemis® team code.

The Team Master Report may be made available for secure access at a website on the World Wide Web or on a LAN. Changes to teams are collected on a monthly basis and applied to Tool 301 (below), and other related tools, per the team change schedule.

FIG. 2 is a high level process flow chart for a specific exemplary embodiment of a demand management tool of the present disclosure. Demand management is the function of tracking, managing and analyzing the impact of demand on projected supply. This may be accomplished by:
Scheduling projects into releases via the Commitment process.
Adding and removing projects into and out of releases via the Appeals process.
Providing a “Planning View” of projects targeting future releases.

Turning to FIG. 2, Annual Release Plan 201 factors into commitment schedule 202 to set date 203 to start the commitment process. Targeted Release Project List 207 provides a list of prioritized projects and targeted releases 208. HLD Estimates 205 allows project managers to validate release eligibility 206 for each prioritized project 208.

Date 203, eligibility 206 and list 208 together satisfy entrance criteria 204. If the answer to the question “are entrance criteria met?” is yes 209, match supply and demand and produce reports 210. Review reports and negotiate and obtain commitment 211. Communicate commitment 212 to management.

If the answer to the question “are entrance criteria met?” is no, retarget the project for the next release 213 or appeal 131.

The Release Commitment process is used to schedule prioritized projects into releases. The commitment schedule is based on timelines defined for releases in the business' annual plan. Prior to commitment, projects are considered to be targeted for a release. After commitment, projects are scheduled in a release and are considered to be a commitment to the client and a commitment of resources to the development through deployment phases.

Certain activities are recommended to be completed before Release Commitment. Pre-commitment activities include (1) prepare a commitment schedule for commitment activities and dates; (2) update the Targeted Release Project List; (3) baseline the HLDs; and (4) ensure that the targeted projects are eligible for commitment.

To facilitate the communication of eligible projects, a tool of the present disclosure may process commitment data and matches requested demand to supply. Additionally, the Eligible Project List may be published.

To prepare for Commitment, review the Eligible Project List and supporting Reports (such as, for example a Detail Demand Report and Over-Under Team Report) for potential supply issues. Identify other issues that may prohibit commitment, such as dependencies or conflicts with other projects.

Place a commitment call to obtain commitment. A tool of the present disclosure processes the commitment results and the Committed Project List is published.

Appeal Process 131 may be used for adding and removing projects committed to a release. Appeals are managed by Release Management 129. Projects being appealed are assessed by the development and testing teams and approved for acceptance into the release. Approved appeals are processed in a Tool 301 of the present disclosure and are reflected in the Detail Demand and Over Under Reports.

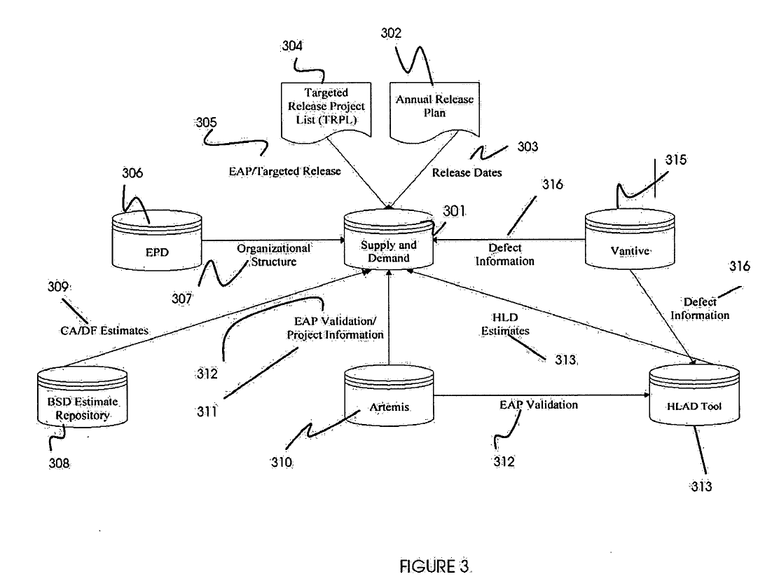

FIG. 3 is a high level process flow chart for a specific exemplary embodiment of an IT resource supply and demand management tool interface of the present disclosure. Supply and Demand Tool 301 receives input from a variety of factors. Annual Release Plan 302 provides release dates 303 to tool 301. List 304 provides EAP and targeted release 305 information to tool 301. EPD 306 provides organizational structure 307 information to tool 301. CAE Tool 308 provides CA/DF estimates 309. A Third party reporting tool 310, such as, for example Artemis®, may provide EAP validation 312 and Project information 311 to tool 301. Reporting tool 310 also provides EAP validation information 312 to HLAD Tool 313. HLAD Tool 313 provides HLD estimates 313 to supply and demand tool 301.

Vantive™, for example, 315 may provide defect information both to supply and demand tool 301 and to HLAD Tool 313. HLD estimates may take defect information 316 into account prior to being provided by HLAD Tool 313 to tool 301.

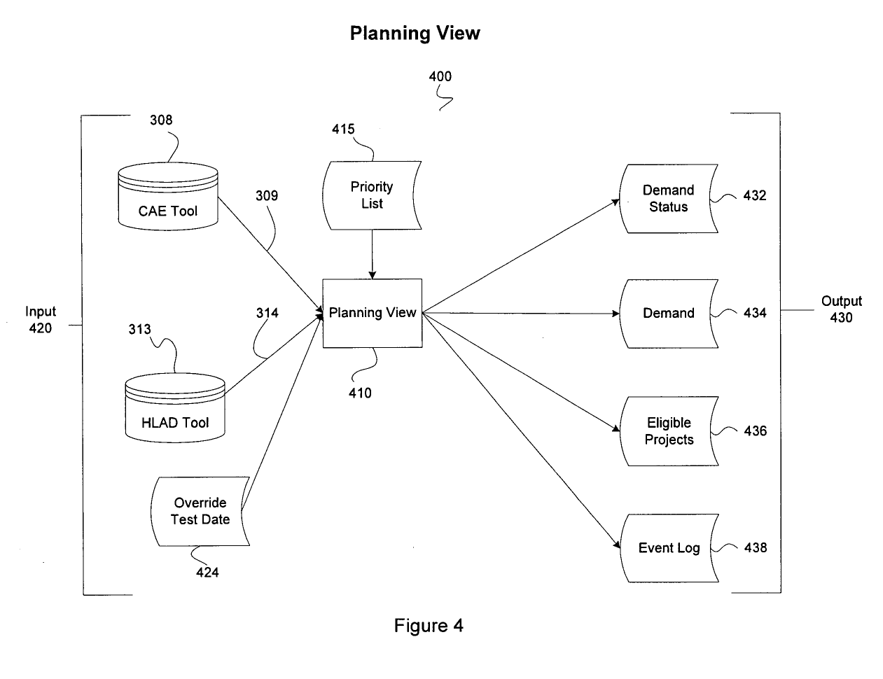

FIG. 4 is a high level process flow chart for a specific exemplary embodiment of a planning view of the present disclosure. Specific embodiments of the present disclosure provide Planning View 410, which includes, for example, the Detail Demand and Over-Under Reports to display the contents of Planning View 410. Planning View 410 provides a view of projects not yet committed and the potential impact on projected supply. For example, it may provide a heads up on upcoming demand early in the process. Projects may be included in the View as soon as they are prioritized 208 and a CAE or later estimate is available for the project. Planning view 410 allows for earlier planning for possible resource sharing opportunities.

Input components 420 of Planning View 410 include a CAE Tool 308, and HLAD Tool 313, test override date 424 and priority list 415. From Planning View 410, select a project from priority list 415 for a release that is not currently in commitment. Determine the most current estimate from either one of the HLAD 313, DF 309 or CAE 308 (for a non-commitment process team, ignore the estimates). If estimates do not exist for the project/team/release, spread estimates based on the release time frame and the team's spreads. If estimates do exist for the project/team/release, apply the current estimates based on the existing percentage spread ratio and set the project status as “Planned.” Planning View 410 output 430 includes, but is not necessarily limited to, components such as demand status 432, demand 434, Eligible Projects 436 and event log 438.

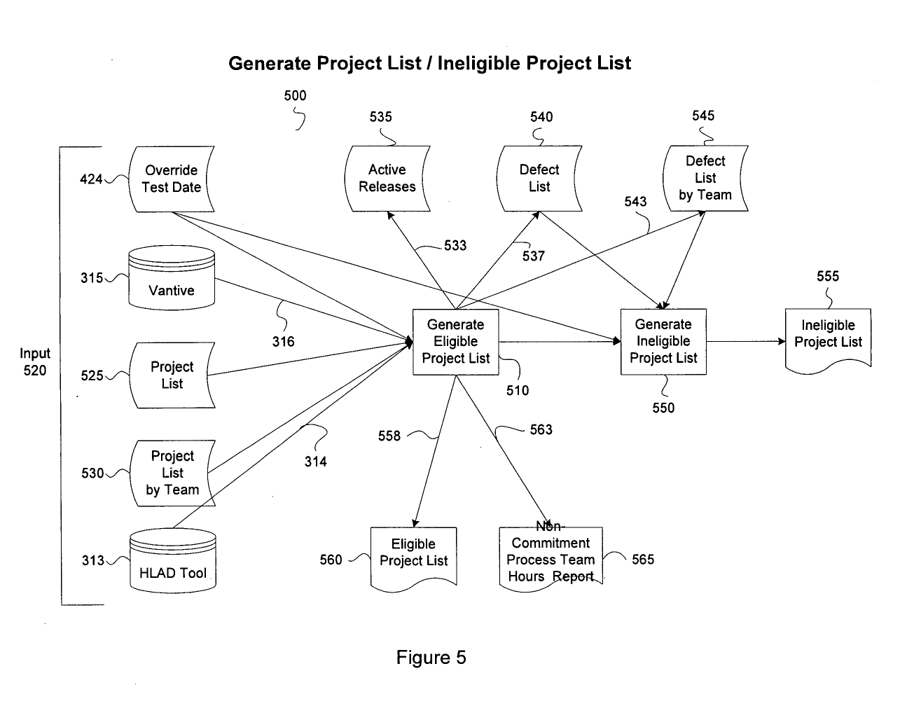

FIG. 5 is a high level process flow chart for a specific exemplary embodiment of a process to generate a project list/ineligible project list of the present disclosure. Generate eligible project list task 510 uses input from Override Test Date 424, defect information 316 from, for example, Vantive® 315, Project List 525, project list by team 530, and HLAD Tool 313. Determine 533 the active releases 500. Generate 537, 543 defect list 540 and defect list by team 545 to generate 550 list of ineligible projects 555. Further, generate 558,563 eligible project list 560 and non-commitment process team hours reports 565.

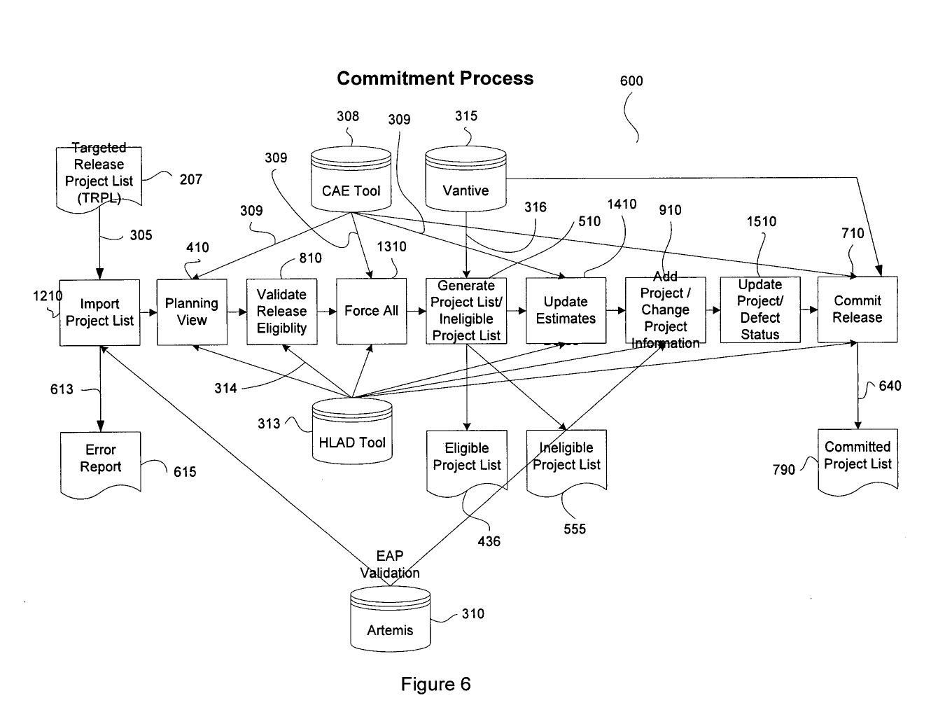

FIG. 6 is a high level process flow chart for a specific exemplary embodiment of a commitment process of the present disclosure. Commitment begins with Target Release Project List (TRPL) 207. Import the project list 1210. Validate projects from, for example, Artemis® 310, to Planning View 410 (invalid entries generate an error list) using HLAD Tool 313 and CAE Tool 308. Defective importation generates 613 error report 615. Validate release eligibility 810 with HLD estimates 314 and CA/DF estimates 309 to force all 1310. Generate project list and ineligible project list 510 with defect information 316 from Vantive®315. Update estimates 410 (HLAD Tool 313, CAE Tool 308) and add/change project information 910 with Artemis® (and HLAD Tool 313). Update project/defect status 1510. Commit to release 710 (CAE Tool 308, HLAD Tool 313, Vantive® 315) and generate 640 committed project list 790.

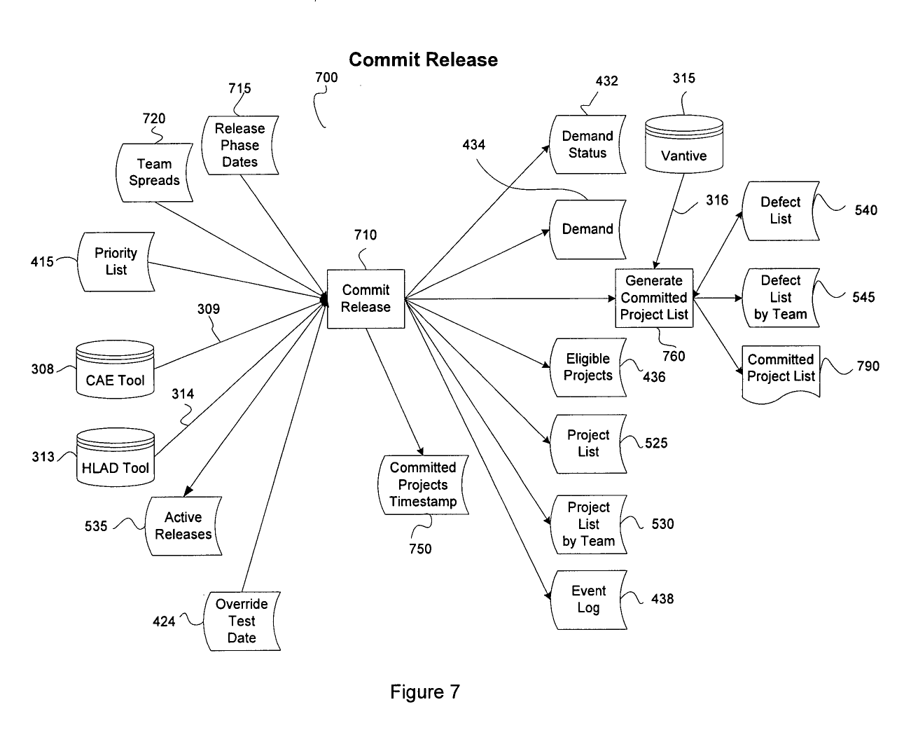

FIG. 7 is a high level process flow chart for a specific exemplary embodiment of a commit release process of the present disclosure. To the left of Commit Release icon 710 are examples of the various factors and tools that affect Commit Release, such as Release Phase Dates 715, Team Spreads 720, Priority List 415, CAE Tool 308 (CA/DF Estimates 309), HLAD Tool 313 (HLD Estimates 314), Active Release 535, and Override Test Date 424. To the right of the icon are examples of the products of the Commit Release 710, such as Demand Status 432, Demand 434.

Additional out put of Commit Release 710 may include Eligible Projects 436, Project List 525, Project List by Team 530, and Event Log 438. Commit Release 710 may also generate Committed Project List 760 with additional input from Vantive® 315 (which may include defect information 316), to create Defect List 540, Defect List by Team 545 and Committed Project List 790. Commit Release 710 may also update Committed Projects Timestamp 750.

A user may optionally select a project from Priority List 415 for active releases to begin Commit Release 710. The user gets HLD estimate 314 and may spread estimates based on the release timeframe and the team's spreads. Other functions may include drop non-commitment process hours from the reports; set project status to “Committed;” Update interface tables; and complete Planning View 410 for all other active releases.

To generate Committed Project List 760, determine the active releases, update defect information 316, get project information, format a report (e.g., Excel®) 790, update interface tables 525, 530, 540, 545, and clear active releases 535.

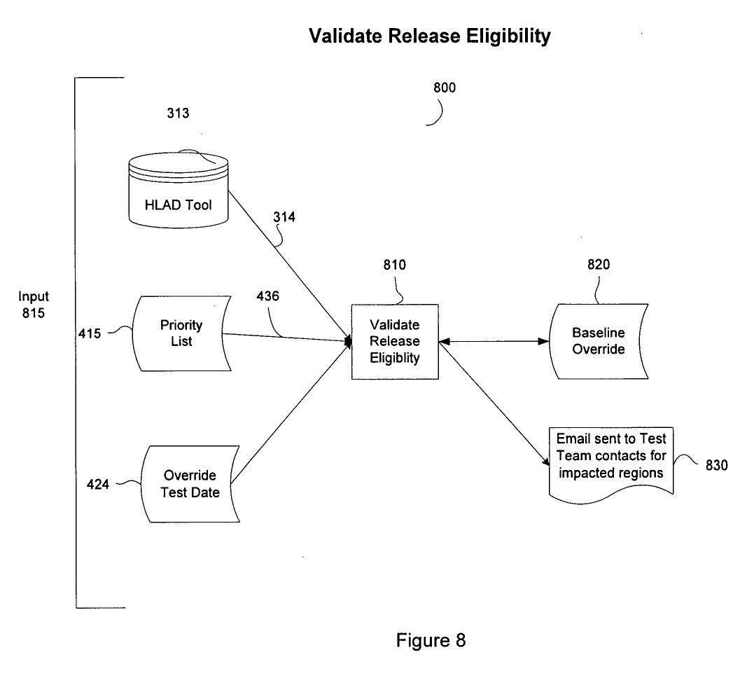

FIG. 8 is a high level process flow chart for a specific exemplary embodiment of a process of the present disclosure to validate release eligibility 810. Input factors include HLD estimates 314 from HLAD Tool 313, eligible projects 436 from Priority List 415 and Override Test Date 424. A tool of the present disclosure may display an online selection screen of EAP numbers and titles. The user may select an EAP number from the list and corresponding EAP information is displayed, such as commit and deploy release, the current HLD estimate, eligibility status, the last update time and the identity of the last updater, and associated comments. The user may update eligibility as Eligible or Not Eligible. Comments may be required if the status is updated as Not Eligible. Baseline Override 820 feeds back dynamically to process 810. Validation results may be emailed 830 to Test Team contacts for each impacted region.

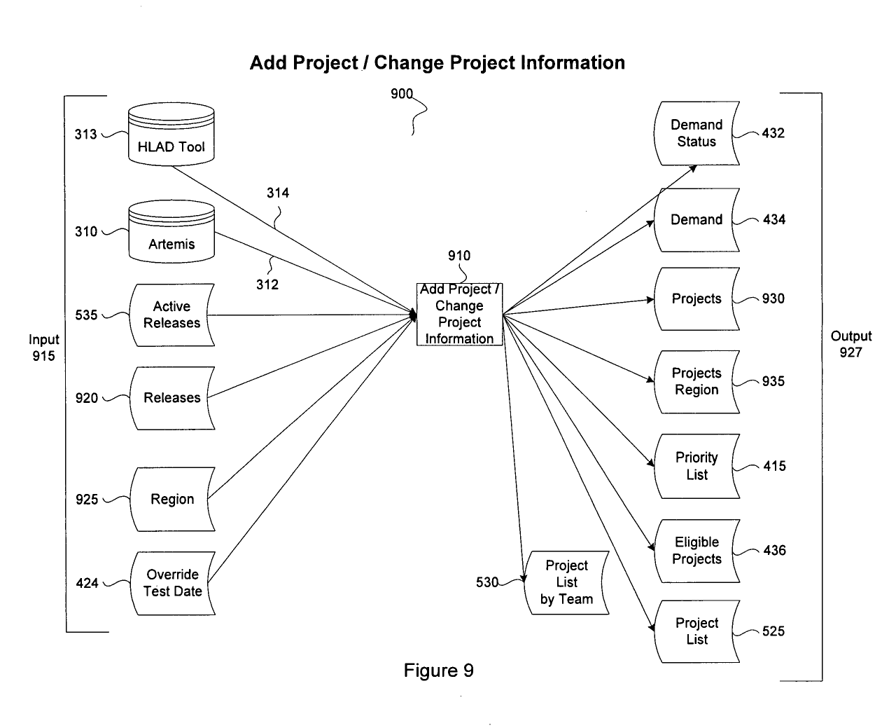

FIG. 9 is a high level process flow chart for a specific exemplary embodiment of a process of the present disclosure to add project/change project information. Factors affecting Add/Change function 901 of the present disclosure may include HLD estimates 314 from HLAD Tool 313, EAP validation 312 from Artemis® 310 (for example), Active Release 535 and Release Information 920, information about Affected Region 925 and Override Test Date 424. Outputs affected by the Add/Change function may include Demand Status 432 and Demand 434, Projects 930 and Projects Region 935, Priority List 725, Eligible Projects 436 and Project List 525 and Project List by Team 530.

A tool of the present disclosure may display a drop down list of the release types for the administrator to select a release type from the drop down list. The EAP number may be a valid number from, for example, Artemis®, but not an already committed project. The commit release status may be “release” in the drop down list. A “deploy release” is any release for the release type not yet deployed. The project region is any region in the region table. The priority is any numeric priority (optionally, an alphanumeric field). “Dependent projects” is an optional alphanumeric field. “Comments” may be a required field used to describe the reasons or how the project was added or modified during commitment. Click “submit” (or other comparable function) to validate the information and add it to the corresponding tables.

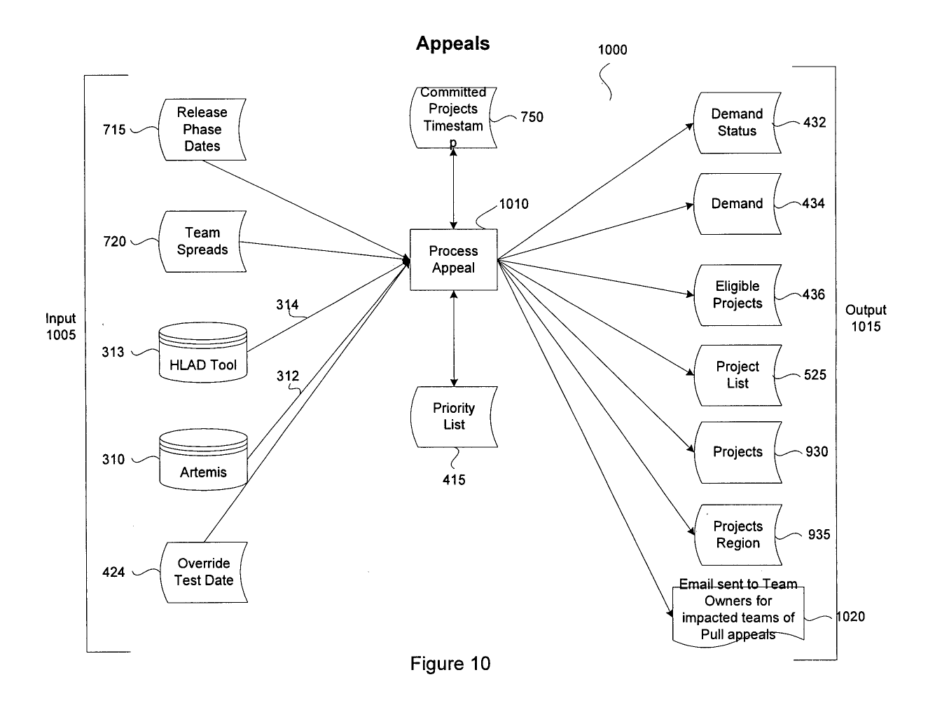

FIG. 10 is a high level process flow chart for a specific exemplary embodiment of an appeals process of the present disclosure. Factors 1005 affecting Appeal Process 1010 may include Release Phase Dates 715, Team Spreads 720 and Override Test Date 424. Additional factors 1005 may include HLD estimates 314 from HLAD Tool 313 and EAP Validation 312 from, for example, Artemis® 310. Appeal process 1010 has a dynamic feedback relationship to Priority List 415 and Committed Projects Timestamp 750. Outcomes 1015 from Appeal process 1010 affect a variety of components of the present tool, including, for example, Demand Status 432 and Demand 434, Eligible Projects 436 and Project List 525, together with Projects 930 and Projects Region 935. Team owners of impacted teams may be notified of Pull appeals 1020.

In practice, an administrator may optionally select “appeal type” from a dropdown list and selects “release type” from the list. For Adds, the EAP must be a valid project in Artemis®, for example, that is not currently committed to a release. For Pulls, the EAP must be currently committed to an active release. “Release” is an active release that is not yet deployed. “Region” is any combination of regions currently listed in the Region table. The effective date is the effective date of the appeal. Preferably, the effective date should not be a future date. Click “submit,” or other equivalent function, to validate the information, retrieve the HLDE for the project and spread the estimates for each team, based on the release timeframe and the team's spreads.

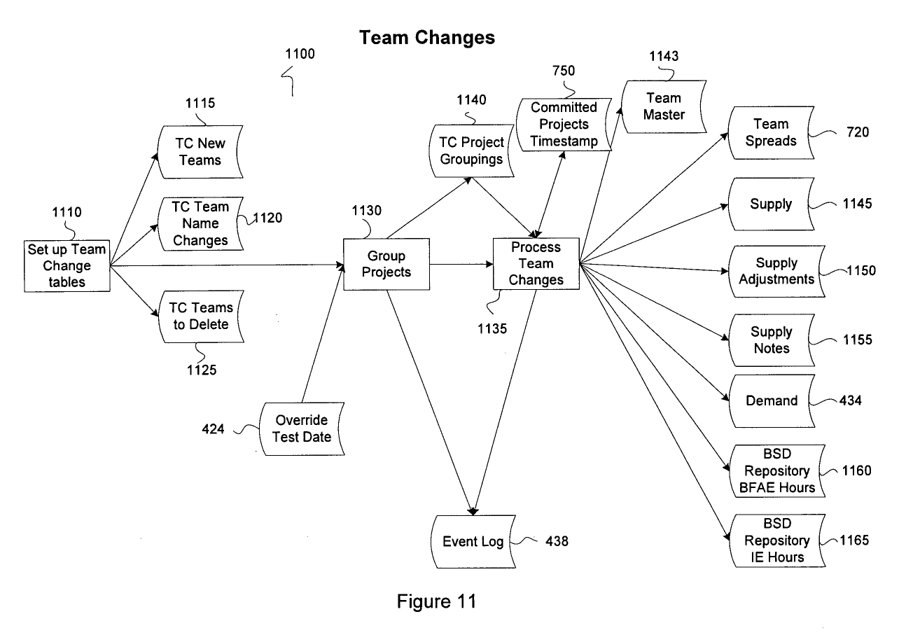

FIG. 11 is a high level process flow chart for a specific exemplary embodiment of a process of the present disclosure to implement team changes. The process is initiated by setting up Team Change Tables 1110, including information such as New Teams 1115, Team Name Changes 1120 and Teams to Delete 1125. Group together 1130 the projects that involve team changes and process the team changes 1135. Factors affected by team changes may include Team Spreads 720, Resource Supply 1145, Supply Adjustments 1150, Supply Notes 1155, Demand 434, BFAE hours 1160 and IE hours 1165. The event log 424 may be updated to indicate the start and completion of the Team Change process.

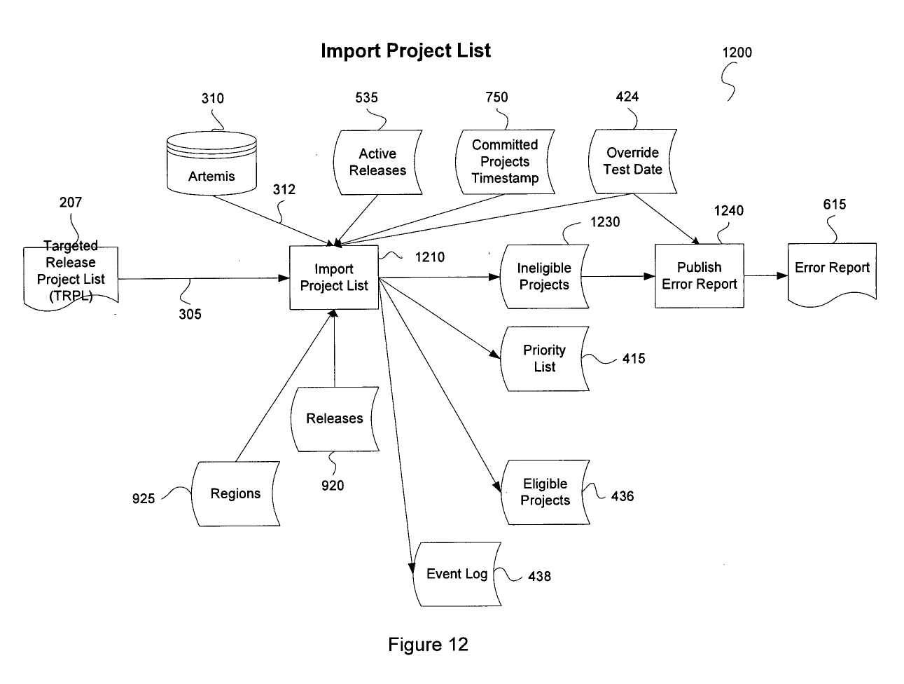

FIG. 12 is a high level process flow chart for a specific exemplary embodiment of an import project list process 1210 of the present disclosure. Import Project List 1210 draws from Committed Projects Timestamp 750 as well as from other information. Ineligible Projects 1230 trigger Published Error Report function 1240 to yield Error Report 615. Common edits include but are not limited to: 1) A given project cannot already be committed and be on Priority List 415 to be imported; 2) A commit release is in the Release table and has not been deployed;

3) Deploy release resides in the Release table, not yet deployed, and is equal to or greater than the commit release; 4) The region is in the Region table; 5) EAP is in Artemis®, for example; 6) Preferably, commit release is not currently in commitment; 7) The list is in numeric priority number and does not include duplicate projects.

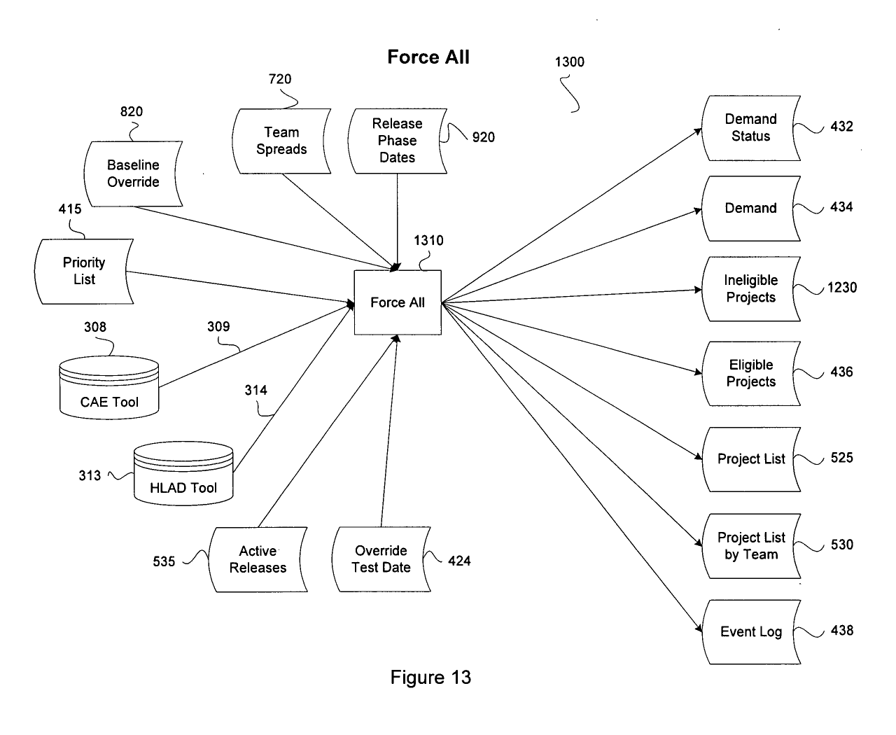

FIG. 13 is a high level process flow chart for a specific exemplary embodiment of a Force All process 1310 of the present disclosure. A user may optionally select a project from the priority list for active release and gets the HLD estimates. The user determines whether the project is eligible for commitment. Projects are ineligible for commitment when the HLDE equals zero, is currently marked NOT ELIGIBLE, or is never marked eligible. Spread estimates are based on the release timeframe and the team's spreads. Non-commitment process team hours may be dropped from the reports. The project status may be set to “Proposed.” Planning view 410 may be completed for all other active releases.

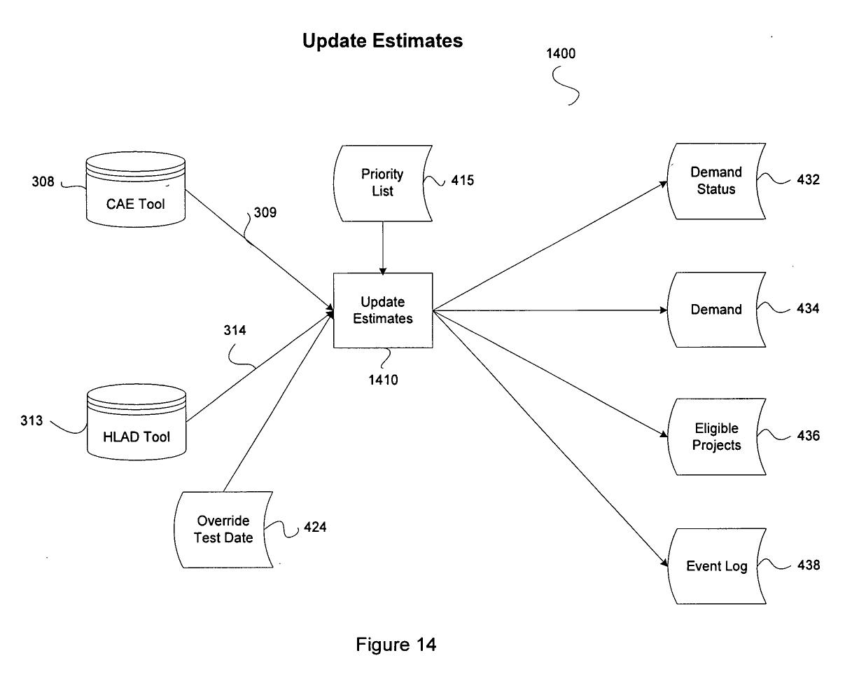

FIG. 14 is a high level process flow chart for a specific exemplary embodiment of a process of the present disclosure to update estimates 1410. For each project on the Priority List 415 the tool may determine the most current estimate 309, 314 (HLD, DF, or CA). The estimates may be applied to the existing percentage spread ratio. If estimates do not exist for the project, team, or release, estimates may be spread based on the release timeframe and the team's spreads. Estimates may be ignored for non-commitment process teams.

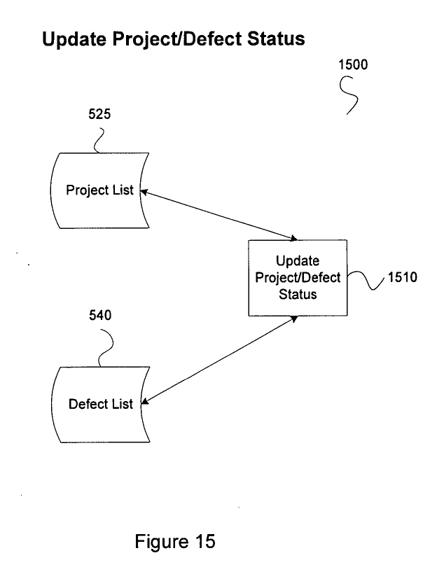

FIG. 15 is a high level process flow chart for a specific exemplary embodiment of a process of the present disclosure to update project/defect status 1510. An administrator may select “Project” or “Defect” from a dropdown list and may select the release type, also from a dropdown list, and changes the current status from “proposed” to “excluded” or from “excluded” to “proposed.” “Release” may be selected from a Commit Release dropdown list. Another dropdown list may provide a plurality of reasons that may be selected, including an “other” option, and the user selects one of the reasons. The application may prompt the user for comments if “other” is selected as the reason. Another reason provided by the dropdown list may be “Supply Constraints.” One or more critical path teams may be chosen by the user if “supply constraints” is selected as a reason. Clicking “Update,” or some other equivalent function, updates the status in the corresponding tables.

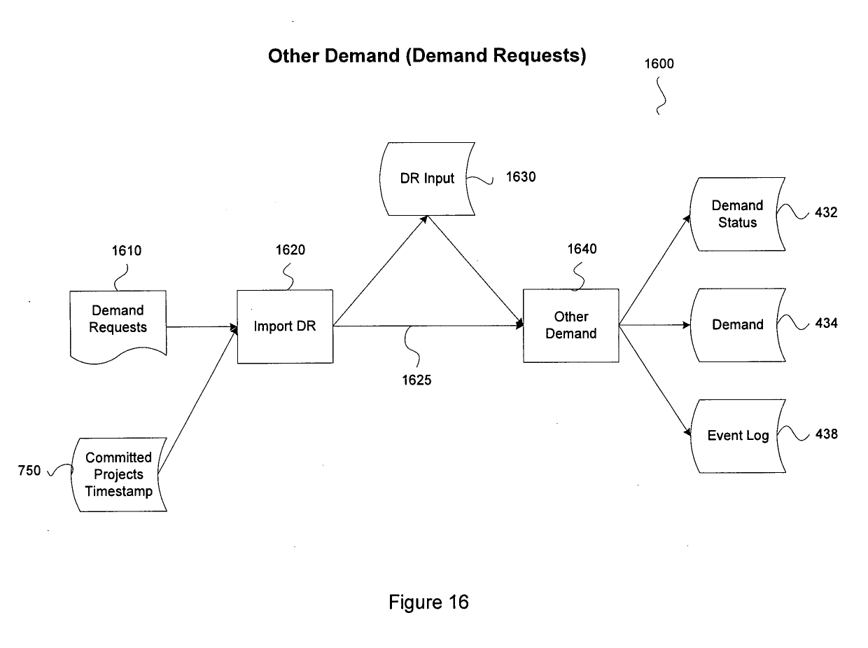

FIG. 16 is a high level process flow chart for a specific exemplary embodiment of an Other Demand (Demand Requests) process of the present disclosure. Demand Requests 1610 and Committed Projects Timestamp 750 are gathered in Import DR function 1620 and, together with DR Input 1630, imported 1625 to Other Demand 1640. A tool of the present disclosure imports demand requests. Importation is facilitated, for example, by converting Excel® data to Access® data. Determine whether the Demand Request contains an EAP that has already been committed to a release and that all EAPs are valid in Artemis®, for example. Estimates may be stored in a temporary SQL table, for example. Imported Demand Requests generate Other Demand 1640, which commits the demand to the associated tables.

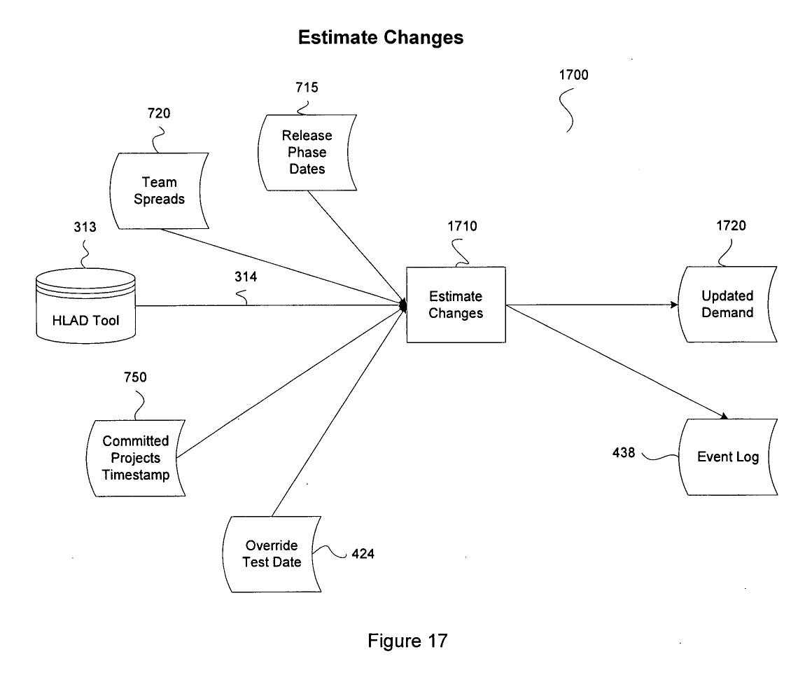

FIG. 17 is a high level process flow chart for a specific exemplary embodiment of a process of the present disclosure to Estimate Changes 1710. Factors affecting estimate changes may include Release Phase Dates 715, Team Spreads 720, HLD estimates 314, and Committed Projects Timestamp 750. Process 1710 yields Updated Demand 1720. It selects all projects that are committed but that are not yet deployed and gets HLD estimate 314 for the selected projects. Spread estimates may be based, for example, on release timeframe and a team's spread 720. Non-commitment process team hours are dropped from reports. The Estimate Change process 1710 may be optionally run as a scheduled nightly batch process or run on demand.

Supply and Demand reports of a tool of the present disclosure include details of demand and projected utilization of supply. Commonly used reports may include:

Over Under Team Report

Over Under Rollup Report

Detail Demand Report

Additional reports that may be particularly useful for Release Management may include the Release Eligibility Status Report and the Planned Project Summary Report. These reports may be accessed, for example, from the Reports option on the Tool 301 web site.

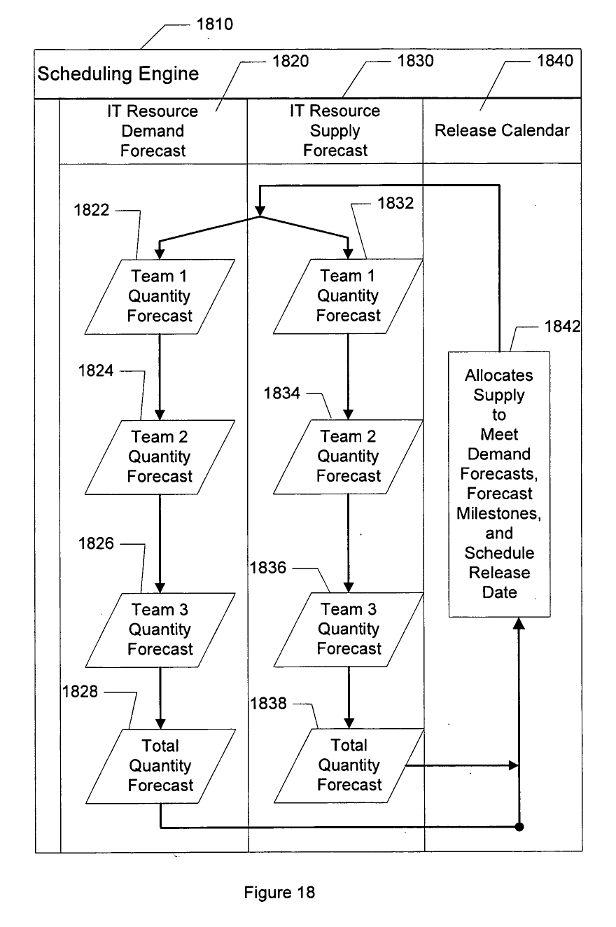

FIG. 18 is a process flow chart of a specific exemplary embodiment of a scheduling engine of the present disclosure. Scheduling engine 1810 may include IT resource demand forecast column 1820, IT resource supply forecast column 1830 and release calendar column 1840. The IT resource demand forecast may include the demand forecasts of each team contributing to a project. Demand forecasts from Team 1 1882, Team 2 1824, and Team 3 1826, and so forth, create Total resource demand forecast 1828. Likewise, the IT resource supply forecast may include the supply forecast from Team 1 1832, Team 2 1834, and Team 3 1836 to yield Total resource supply forecast 1838. Release Calendar 1840 iteratively calculates the supply remaining when scheduling projects in release, schedules and commits projects to a release date, and applies 1842 Total demand forecast 1828 spreads to Teams 1, 2 and 3, for example, based on dates associated with the deploy release and the demand forecast spreads.

Advantageously, the management tool of the present disclosure may utilize forecasts rather than actual data. Project management tools that rely on actual data must use past or current data to simply extrapolate into the future to determine whether a project is on schedule. By asking for forecasts, the present tool may provide a more realistic picture of the project trajectory and may allow project managers to more accurately anticipate future changes in IT resource supply and demand. The present tool may interface with other tools to integrate data such as time, status and reporting data, but utilizes forecasts to provide a global view as to whether a project is on track to meet a scheduled deploy release date. Another advantage of the present tool is that it may enable teams that are over allocated to search for resources from other teams that have available resources with specific skills.

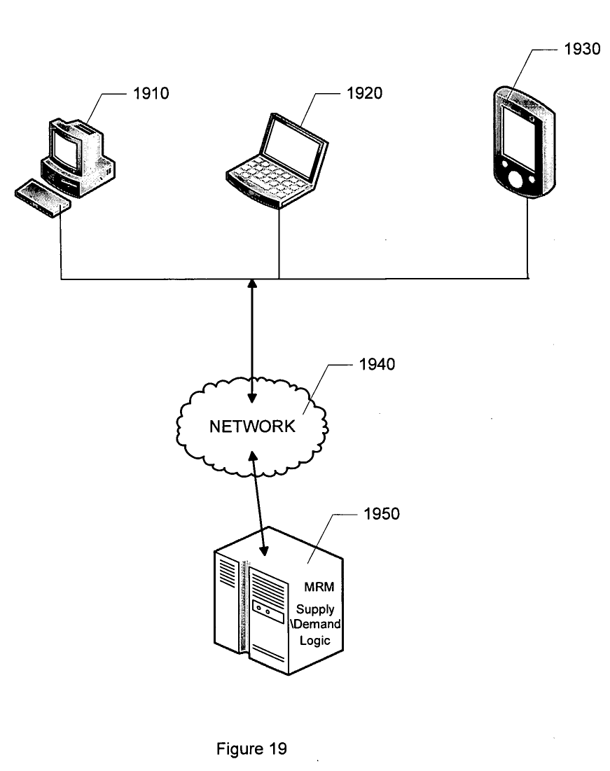

FIG. 19 is a diagrammatic illustration of a specific exemplary embodiment of a network of the present disclosure. Network 1940 has one or more telecommunications media such as telephone wireline, wireless, broadband, coaxial cable, fiber optic, and so forth, that may enable remote terminals 1910, 1920 and 1930, to communicate with scheduling engine 1950 of the present disclosure. Examples of remote terminals may include Personal Computer (PC) or workstation 1910, laptop 1920, Personal Digital Assistant (PDA) 1930 and so forth. Remote terminals 1910, 1920 and 1930 may communicate with scheduling engine 1950 via telecommunications network 1940. Network 1940 may include, for example, the World Wide Web, the Internet; a virtual private network (VPN), and the like, to enable scheduling engine 1950 to receive input from the remote terminals regarding, for example, supply or demand forecast changes, milestone achievement dates and other relevant information to update the resource spreads.

It is worth noting, that although described in reference to IT resources, the present disclosure has broad application to a variety of enterprises that must effectively allocate resources for a multiplicity of complex projects. For example, film and video game production enterprises would find advantages in the present disclosure. As would municipalities that must allocate scarce resources to public improvements projects, for instance.

In accordance with various embodiments of the present disclosure, the methods described herein are intended for operation as software programs running on a programmable machine, such as a computer processor. Dedicated hardware implementations including, but not limited to, application specific integrated circuits, programmable logic arrays and other hardware devices can likewise be constructed to implement the methods described herein. Furthermore, alternative software implementations including, but not limited to, distributed processing or component/object distributed processing, parallel processing, or virtual machine processing can also be constructed to implement the methods described herein.

It should also be noted that the software implementations of the present disclosure as described herein are optionally stored on a tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to e-mail or other self-contained information archive or set of archives is considered a distribution medium equivalent to a tangible storage medium. The disclosure is considered to include a tangible storage medium or distribution medium, including a propagated signal, as listed herein and including art-recognized equivalents and successor media, in which the software implementations herein are stored.

Accordingly, those skilled in the art will recognize that the present disclosure extends to machine-readable media (“MRM”) containing instructions for execution by a computer. MRM is broadly defined to include any kind of computer memory such as floppy disks, conventional hard disks, CD-ROMs, Flash ROMS, nonvolatile ROM, RAM, Storage Media, email attachments, solid state media, magnetic media, and signals containing instructions, together with processors to execute the instructions.

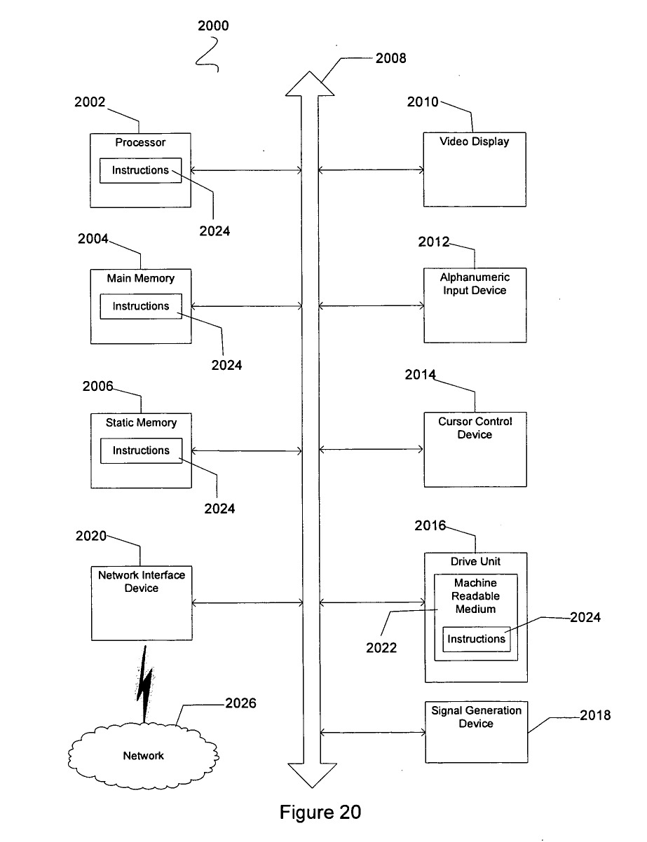

FIG. 20 is a diagrammatic representation of a machine in the form of a computer system 2000 within which a set of instructions, when executed, may cause the machine to perform any one or more of the methodologies discussed herein. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment. The machine may comprise a server computer, a client user computer, a personal computer (PC), a tablet PC, a set-top box (STB), a Personal Digital Assistant (PDA), a cellular telephone, a mobile device, a palmtop computer, a laptop computer, a desktop computer, a personal digital assistant, a communications device, a wireless telephone, a land-line telephone, a control system, a camera, a scanner, a facsimile machine, a printer, a pager, a personal trusted device, a web appliance, a network router, switch or bridge, or any machine capable of executing a set of instructions (sequential or otherwise) that specify actions to be taken by that machine. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 2000 may include a processor 2002 (e.g., a central processing unit (CPU), a graphics processing unit (GPU), or both), a main memory 2004 and a static memory 2006, which communicate with each other via a bus 2008. The computer system 2000 may further include a video display unit 2010 (e.g., a liquid crystal display (LCD), a flat panel, a solid state display, or a cathode ray tube (CRT)). The computer system 2000 may include an input device 2012 (e.g., a keyboard), a cursor control device 2014 (e.g., a mouse or a remote control), a disk drive unit 2016, a signal generation device 2018 (e.g., a speaker or remote control) and a network interface device 2020.

The disk drive unit 2016 may include a machine-readable medium 2022 on which is stored one or more sets of instructions (e.g., software 2024) embodying any one or more of the methodologies or functions described herein, including those methods illustrated in herein above. The instructions 2024 may also reside, completely or at least partially, within the main memory 2004, the static memory 2006, and/or within the processor 2002 during execution thereof by the computer system 2000. The main memory 2004 and the processor 2002 also may constitute machine-readable media. Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 2024, or that which receives and executes instructions 2024 from a propagated signal so that a device connected to a network environment 2026 can send or receive voice, video or data, and to communicate over the network 2026 using the instructions 2024. The instructions 2024 may further be transmitted or received over a network 2026 via the network interface device 2020.

While the machine-readable medium 2022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The term “machine-readable medium” shall accordingly be taken to include, but not be limited to: solid-state memories such as a memory card or other package that houses one or more read-only (non-volatile) memories, random access memories, or other re-writable (volatile) memories; magneto-optical or optical medium such as a disk or tape; and carrier wave signals such as a signal embodying computer instructions in a transmission medium; and/or a digital file attachment to e-mail or other self-contained information archive or set of archives is considered a distribution medium equivalent to a tangible storage medium. Accordingly, the description is considered to include any one or more of a machine-readable medium or a distribution medium, as listed herein and including art-recognized equivalents and successor media, in which the software implementations herein are stored.

Although the present specification describes components and functions implemented in the embodiments with reference to particular standards and protocols, the disclosure is not limited to such standards and protocols. Each of the standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same functions are considered equivalents.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are merely representational and may not be drawn to scale. Certain proportions thereof may be exaggerated, while others may be minimized. Accordingly, the specification and drawings are to be regarded in an illustrative rather than a restrictive sense.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

A tool of the present disclosure has been described with reference to several exemplary embodiments. It is understood, however, that the words that have been used are words of description and illustration, rather than words of limitation. Changes may be made within the purview of the appended claims, as presently stated and as amended, without departing from the scope and spirit of the disclosure in all its aspects. Although the tool has been described with reference to particular means, materials and embodiments, the disclosure is not intended to be limited to the particulars disclosed; rather, the disclosure extends to all functionally equivalent technologies, structures, methods and uses such as are within the scope of the appended claims.

We claim:

1. A machine-readable medium having instructions stored thereon that, when executed by a machine, cause the machine to implement a scheduling engine that calculates a difference between a forecast supply of Information Technology (IT) resources and a forecast demand for the IT resources at an application team level, wherein one or more teams impact the release of a product of a project; the scheduling engine comprising a release calendar, wherein the IT resources are allocated on the basis of a calculated difference between a forecast IT team resource supply and a forecast IT team resource demand to achieve product deployment by a scheduled release date.

2. The medium of claim 1, wherein the scheduling engine further comprises a planning view for high level analysis of resource supply inputs and resource demand outputs.

3. The medium of claim 1, wherein the instructions further cause the machine to generate a list of ineligible projects.

4. The medium of claim 1, wherein the instructions further cause the machine to generate a list of eligible projects.

5. The medium of claim 1, wherein the instructions further cause the machine to generate a list of committed projects.

6. The medium of claim 1, wherein the instructions further cause the machine to generate a commit release.

7. The medium of claim 1, wherein the instructions further cause the machine to validate release eligibility.

8. The medium of claim 1, wherein the IT resources comprise available IT personnel and available work hours.

9. The medium of claim 1, wherein the scheduling engine further comprises an Add Project/Change Project Information function.

10. The medium of claim 1, wherein the scheduling engine further comprises an appeals process.

11. The medium of claim 1, wherein the scheduling engine further comprises a team changes function to process changes in one or more teams and to calculate changes in resource supply or demand from the changes.

12. A machine-readable medium having instructions stored thereon that, when executed by a machine, cause the machine to implement a scheduling engine that calculates a difference between a supply of Information Technology (IT) resources and a demand for the IT resources at an application team level, wherein one or more teams impact the release of a product of a project by a scheduled release date; the scheduling engine comprising:
a release calendar, wherein the IT resources are allocated pursuant to fixed milestones to achieve product release by a fixed release date;
a planning view for high level analysis of IT resource supply inputs and IT resource demand outputs;
an Add Project/Change Project Information function; and
a team changes function to process changes in one or more teams and to calculate changes in IT resource supply or demand.

13. The medium of claim 12, wherein the instructions further cause the machine to accept entrance criteria for entry of a project into the scheduling engine.

14. The medium of claim 13, wherein the instructions further cause the machine to determine whether a proposed project meets the entrance criteria.

15. The medium of claim 14, wherein the instructions further cause the machine to reject a project which does not meet the criteria for entry into the scheduling engine.

16. The medium of claim 15, wherein the instructions further cause the machine to target a rejected project for an appeal process.

17. The medium of claim 15, wherein, for a project rejected as to a first scheduled release date, the instructions further cause the machine to target the rejected project for an entrance criteria determination as to a second scheduled release date.

18. The medium of claim 12, wherein one or more application teams are assigned to a project and one or more application teams are not assigned to the project, wherein at least one IT resource allocated by the scheduling engine to an application team assigned to the project is drawn from an application team not assigned to the project.

19. A machine-readable medium having instructions stored thereon that, when executed by a machine, causes the machine to implement a scheduling engine that calculates a difference between a forecast supply of Information Technology (IT) resources and a forecast demand for the IT resources at an application team level, wherein one or more teams impact the release of a product of a project, wherein the IT resources are allocated on the basis of a calculated difference between a forecast IT team resource supply and a forecast IT team resource demand to achieve product release by a fixed release date;
wherein the instructions further cause the machine to:
generate a list of ineligible projects;
generate a list of eligible projects;
generate a list of committed projects; and
generate a commit release date for each of the committed projects.

20. A network for use in the management of resource supply and demand, the network comprising:
one or more telecommunications media for transmitting data;
a server connected to a remote terminal by the telecommunications media; and
a machine-readable medium having instructions stored in the server that, when executed by a machine, cause the machine to implement a scheduling engine that calculates the difference between the forecast supply of Information Technology (IT) resources and the forecast demand for the IT resources at an application team level, wherein one or more teams impact the release of a product of a project; the scheduling engine comprising a release calendar, wherein the resources are allocated on the basis of a calculated difference between a forecast IT team resource supply and a forecast IT team resource demand to achieve product deployment by a scheduled release date;
wherein the scheduling engine is at least partially operable from the remote terminal to provide for management of IT resource supply and demand.
